(19) United States
(12) Patent Application Publication
(10) Pub. No.: US 2008/0103221 A1
(43) Pub. Date: May 1, 2008

(54) Crosslinked Polymer Foam Sheet and Process Therefor

(76) Inventors: Emanuela Alexandra Weinbeck, 'sHertogenbosch (NL); Cornelis Remco Willemse, Weert (NL)

Correspondence Address: MH2 TECHNOLOGY LAW GROUP, LLP, 1951 KIDWELL DRIVE, SUITE 550, TYSONS CORNER, VA, 22182, US

(21) Appl. No.: 11/718,783

(22) PCT Filed: Nov. 8, 2005
(86) PCT No.: PCT/EP05/11947

§ 371 Date: Oct. 4, 2007

(30) Foreign Application Priority Data
Nov. 8, 2004 (EP) 04026480.6

(51) Int. Cl. C08J 9/14

(52) U.S. Cl. 521/79; 521/92; 521/97

(57) ABSTRACT

The invention provides a process for the production of a 5 crosslinked polymer foam, which comprises the following steps: (I) blending a polymer with a blowing agent, (II) forming the blend into a sheet, (III) crosslinking the sheet, and (IV) foaming the sheet, wherein the blowing agent is blended in an amount of 3 to 25 based on the total weight of the polyolefin and the blowing agent, and is composed of (A) 3 to 50% of one or more inorganic carbonates and (B) 50 to 97 of one or more compounds selected from the group consisting of polycarboxylic acids, salts thereof, and derivatives thereof.

### FIELD OF THE INVENTION

The present invention relates to a process for the production of a crosslinked polymer foam, a crosslinked polymer foam obtainable by said process and the use of said crosslinked polymer foams.

### BACKGROUND ART

From the literature (e.g. Klemper/Frisch; Polymeric foams; Hanser Publishers, 1991, chapter 9) it is known that crosslinked polyolefin foams can be obtained via chemical crosslinking and radiation crosslinking. Both routes consist of the following steps:
mixing the polymers with 1. a chemical blowing agent (radiation crosslinking or 2. a chemical blowing agent and a crosslinking agent, e.g. a peroxide or silane;
extruding a sheet;
in case of radiation crosslinking: crosslinking the extruded sheet;
heating the sheet in a oven leading to:
   decomposition of the peroxide in case of chemical crosslinking followed by the crosslinking of the polymer;
   decomposition of the chemical blowing agent leading to the foam.

From the literature (e.g. Klemper/Frisch; Polymeric foams; Hanser Publishers, 1991, chapter 9) it is also known that the suitable chemical blowing agent for these processes are exothermic foaming agents like azodicarbonamide, N,N′-Dinitrosopentamethylenetetramine, or 4,4-Oxybis (benzenesulfonylhydrazide). It is also mentioned that endothermic blowing agents, like sodiumbicarbonate is unsuitable since it begins to decompose at temperatures below the melting temperature of most polyolefins and its decomposition temperature range is undesirably broad. Moreover its decomposition products, carbondioxide and water, diffuse through the polyolefines much faster than air, causing unwanted foam shrinkage. Mixtures of sodium bicarbonate and citric acid are used as nucleators for direct extrusion blowing process of low density plastic foam and as blowing agents in structural foams having densities above 300 kg/m3.

U.S. Pat. No. 3,711,584 describes a wrinkle-free highly foamed sheet of a polyolefin resin having a fine and uniform cellular structure. This foamed sheet was obtained by foaming a void-free crosslinked sheet at temperatures above the decomposition temperature of the chemical blowing agent, azodicarbonamide. This crosslinked sheet can be obtained by radiation curing or by chemical crosslinking of the sheet. For chemical crosslinking an organic peroxide is required having a decomposition temperature below the decomposition temperature of the blowing agent.

EP0329490 describes a chemically crosslinked polyolefin foam in which the chemical blowing agent is selected from the group consisting of azodicarbonamide, dinitropentamethylenetetramine, diphenyl,-4,4-disulfonylamide and p,p oxybis-benzolsulfonesemicarbazide.

EP0704476 describes a crosslinked plastic foam material composed of a polyolefin based resin composition consisting of polypropylene and polyethylene based polymers. The foamable material includes a thermodecomposable foaming agent, being azodicarbonamide or selected from the group consisting 1,1 azobisformamide, benzene sulfonyl hydrazide, dinotrosopentamethylene tetramine, toluene sulfonyl hydrazide, and 4,4-oxybis(benzene sulfonyl hydrazide).

In GB 1079369 a partially crosslinked polymer foam is described which is prepared by adding a foamable composition comprising the polymer and the foaming agent to an extruder and extruding after heating the mixture as a sheet or tube. Typical foaming agents are organic compounds which decompose to give nitrogen or mixtures of alkali or alkaline earth metal carbonates or bicarbonates and an acidic agent which liberate carbon dioxide, e.g. sodium bicarbonate and citric acid.

In GB 1111928 foamed polypropylene is described, which is prepared by feeding polypropylene and a nucleating agent containing a CO₂ liberating component and an acid to the transport zone of an extruder, injecting and mixing an organic foaming agent into the plastic mass in the extruder and extruding the mixture with formation of the foam. The nucleating agent consists preferably of a mixture of sodium bicarbonate and citric acid.

In the patents EP 0461298, U.S. Pat. No. 5,443,769, U.S. Pat. No. 5,674,602 and U.S. Pat. No. 5,925,450 foamed products of polystyrene, e.g. plates, cups and food containers, are described, which are produced by extruding a molten polystyrene resin containing nucleating agents such as sodium bicarbonate and citric acid, and adding gases as blowing agents.

EP483682 A2 discloses a polypropylene-based copolymer foam, wherein azodicarbonamide is used as a foaming agent.

GB1052289A discloses examples with directly extruded non-crosslinked foamed polystyrene, PVC and polyolefines comprising 0.5 to 1 parts of endothermic foaming agents with pentane being the main foaming agent. An amount of 0.5 to 1 parts of substances which could be used as endothermic foaming agents rather provides a function of a nucleating agent instead of a foaming agent.

### Problem to be Solved by the Invention

The technical problem underlying the present invention was to provide a process for the production of crosslinked polymer foams using foaming agents that do not result in the presence of semicarbazide in the foamed product. Further, the foams should ideally, at a given density of the foam, show a smooth, regular surface, have fine cells the cell size approaching that of azodicarbonamide foamed foams, have elasticity and tightness against micro-organisms.

### SUMMARY OF THE INVENTION

The inventors have discovered a process to solve the above problem. In particular, the present invention provides the following process:

1. A process for the production of a crosslinked polymer foam, which comprises the following steps:
(i) blending a polymer with an endothermic blowing agent,
(ii) forming the blend into a sheet,
(iii) crosslinking the sheet, and
(iv) foaming the sheet,
   wherein the blowing agent is blended in an amount of 3 to 25 wt.-%, based on the total weight of the polyolefin and the blowing agent, and is composed of the following endothermic components:
(A) 3 to 50% of one or more inorganic carbonates and
(B) 50 to 97% of one or more compounds selected from the group consisting of polycarboxylic acids, salts thereof, and derivatives thereof.

Furthermore, the present invention provides the following process:

A process for the production of a crosslinked polyolefin foam, which comprises the following steps:
(i) blending a polyolefin with an endothermic blowing agent,
(ii) forming the blend into a sheet,
(iii) crosslinking the sheet, and
(iv) foaming the sheet,

wherein the blowing agent is composed of the following endothermic components:
(A) 5 to 40% of one or more inorganic carbonates,
(B1) 10 to 60% of one or more polycarboxylic acids and/or salts thereof, and
(B2) 10 to 60% of one or more derivatives of polycarboxylic acids.

The preferred embodiments of the invention are defined in the dependent claims and the following specification.

The invention furthermore provides a crosslinked polymer foam obtainable by a process of the invention.

Furthermore, the present invention provides the use of the crosslinked polymer foam of the invention for packaging or sealing food, beverage containers, medical devices, pharmaceuticals and cosmetics, or as a carrier for transdermal applications of medicine or as a plaster.

The polymer foams obtained by the processes according to the invention have the following advantages:

they do not contain semicarbazide traces normally found in polymer foams blown with azodicarbonamide;

they fullfill the new requirements of the European Food Packaging legislation, which demands, that polymer foams have to be blown without Azodicarbonamide;

they have a very pronounced white colour as compared to the foams produced with azodicarbonamide;

they have a density between 20 and 400 kg/m3, preferably 50 an 300 kg/m3;

they have a cell size between 0.05 and 2 mm, preferably between 0.1-0.6 mm;

they show no shrinking after the foaming process.

Since the processes of the invention do not require azodicarbonamides, the foams obtained by a process of the invention have the advantage that they do not contain semicarbazides.

The crosslinked foams has finer closed cells and smoother surfaces as compared to directly extruded non-crosslinked polyolefin foams.

The foams according to the present invention further have, at a given density, a good combination of surface smoothness, prevention against microorganisms, elasticity and fine closed cells.

The foams of the present invention are therefore well suitable as packaging materials in the fields of pharmaceuticals, food and cosmetics.

### BRIEF DESCRIPTION OF THE FIGURE

FIG. 1 (A) shows a foam produced by using a mixture of sodium bicarbonate and a citric acid derivative as a blowing agent (white bar represents 1 mm).

FIG. 1 (B) shows a foam produced by using azodicarbonamide as blowing agent (white bar represents 1 mm).

### DETAILED DESCRIPTION OF THE INVENTION

The polymers that can be used in the process of present invention include Polyolefins, like Polyethylene (LDPE, LLDPE, VLLDPE, HDPE, Metallocene PE), Polypropylene (Homo- and Copolymers) and olefin copolymers (EBA, EMA, EVA) and mixtures thereof and additionally PVC and Polystyrene. Furthermore, the polymers include all polymers having a melting temperature of 130° C. or less. Among the polymers, polyethylenes and ethylene copolymers are preferred.

The blowing agent used in the process of the invention includes inorganic carbonates, like sodium bicarbonate, sodium aluminium hydroxyl carbonate, magnesium carbonate and mixtures thereof and polycarboxylic acids or salts thereof, such as citric acid, fumaric acid, tartaric acid, sodium hydrogen citrate and disodium citrate and mixtures thereof and additionally mixtures of both groups, carbonates and acids, which are normally not suitable for the production of expanded synthetic polymers, especially if the expansion degree is higher then 3 times.

Preferably, no other types of blowing agent are used in the present invention. No semicarbazide forming substance is used as a blowing agent in the present invention, i.e. particularly no azodicarbonamide.

According to the present invention, the blowing agent is preferably a ternary combination of an inorganic salt, a polycarboxylic acid and a polycarboxylic acid derivative. More preferably, the ternary combination is a combination of an inorganic salt, preferably sodiumbicarbonate, citric acid and a citric acid derivative. With such a ternary composition for the blowing agent a good combination of the properties low density, fine cells, closed cells, elasticity and microorganism barrier properties can be obtained. It is preferred that the components citric acid and citric acid derivative are present in approximately stoichiometric amounts although the present invention is not restricted thereto. The citric acid and citric acid derivative may for example be present in an equivalent range of 20:80 to 80:20, 30:70 to 70:30, 40:60 to 60:40 or 50:50.

The density of the obtained polymer foam is measured according to Method ISO 845. Advantageously, the density is from 20 kg/m³ to 400 kg/m³, preferably 80 to 400 kg/m³, more preferably 80 to 300 kg/m³.

The cell size is preferably from 0.05 to 2.0 mm, more preferably from 0.1 mm to 0.6 mm. Advantageously, the cells are closed.

In a preferred embodiment, the temperature of extruding, kneading or calendaring the polymer blend into a sheet is 130° C. or less to prevent the sheet from prefoaming, to get a regular cell structure and a flat foam surface.

The foaming is carried out preferably at a temperature of 180 to 260° C., more preferably at a temperature of 200 to 240° C.

The amount of the foaming agent used is preferably 3 to 25%, more preferably 4 to 20%.

The crosslinking may be carried out by any known method, in particular by radiation, either by electron beam or gamma ray.

The production of the fine-cell crosslinked foam using e.g. sodium bicarbonate and citric acid as blowing agent can be done by a multi-step process, which means
1) mixing/extruding or mixing/kneading or mixing/calendering a polymer matrix sheet
2) crosslinking by
   a) radiation source, like electron beam or gamma ray (Cobalt 60)
   b) chemical crosslinking agents, like organic peroxids
3) foaming
   a) in a vertical or horizontal oven system
   b) in a impregnation process with nitrogen in a autoclave, followed by a free foaming in a oven system.

As regards the process to make a roll or batch foam, the following steps are advantageous:

A. Roll Foams:

1) Extruding/kneading:

Mixing/extruding and/or mixing/kneading/calendering as a film or a sheet, with or without cutting off the sheet.

2) Crosslinking:

Physical crosslinking: by electron beam or gamma irradiation.

3) Foaming:

Through decomposition of an organic blowing agent added during the mixing phase, being a mixture of sodium bicarbonate and citric acid.

4) Expansion process:

a) In a horizontal oven with free expansion.

b) In a vertical oven with free expansion.

B. Batch Foams

1. Mixing/kneading/calendering the polymer with a peroxide as a crosslinking agent and a mixture of sodium bicarbonate and citric acid as blowing agent to a sheet or felt and cutting to size.

2. Foaming/Shaping in a heated press, both chemical crosslinking due to decomposition of the peroxide and foaming to a raw bun due to the decomposition of sodiumbicarbonate/citric acid will occur.

### EXAMPLES

### Comparative Example 1

Sodium Bicarbonate as Blowing Agent

A commercial low density polyethylene is mixed with 5% sodium bicarbonate (e.g. Genitron KA9175) in an extruder at a temperature of 125° C. (melt temperature above 130° C.). After extrusion the sheet is crosslinked by radiation and foamed in an oven at 240° C. A foam with a density of 165 kg/m³ is obtained.

By varying the amount of the foaming agent foams with a density varying between 150 and 400 kg/m³ were obtained. All foams were coarse cell foams, since foaming partially occurred in the extruder. Due to this so-called prefoaming coarse cells and irregular surfaces are obtained.

### Comparative Example 2

Derivatives of Citric Acid as Blowing Agent

A commercial low density polyethylene is mixed with 9% citric acid (e.g. Hydrocerol 534 or Hydrocerol PEX 5012) in an extruder at a temperature of 125° C. (melt temperature above 130° C.). After extrusion the sheet is crosslinked by radiation and foamed in an oven at 200-240° C. A foam with a density of 200 kg/m³ is obtained.

By varying the amount of the foaming agent foams with a density varying between 200 and 400 kg/m³ were obtained. Lower densities were not obtained. Fine cell foams were formed. Unfortunately pin holes and surface blisters were formed.

### Example 3

Mixtures of Sodium Bicarbonate and Citric Acid and its Derivatives

3a. A commercial low density polyethylene resin is mixed with 6% of a mixture of sodium bicarbonate and a citric acid (e.g. Celenex 3P6; Celenex is a citric acid without a citric acid derivtive) in an extruder at a temperature of 125° C. (melt temperature above 135° C.). After extrusion the sheet is crosslinked by radiation and foamed in an oven at 200-240° C. A foam with a density of 300 kg/m³ is obtained. Increasing the amount of foaming agent led to decomposition of the blowing agent in the extruder. Rough foam surfaces and coarse cells were seen.

3b. A commercial low density polyethylene resin is mixed with 5% of a mixture of sodium bicarbonate and a citric acid derivative (e.g. Tracel INC 7200W; i.e. a combination of citric acid and a citric acid derivative) in an extruder at a temperature of 125° C. (melt temperature above 135° C.). After extrusion the sheet is crosslinked by radiation and foamed in an oven at 220-260° C. A foam with a density of 200 kg/m³ is obtained. Fine cells and a smooth surface was seen.

3c. A commercial low density polyethylene is mixed with 10% of a mixture of sodium bicarbonate and a citric acid derivative (e.g. Tracel INC 7200W) in an extruder at a temperature of 125° C. (melt temperature above 135° C.). After extrusion the sheet is crosslinked by radiation and foamed in an oven at 190-230° C. A foam with a density of 125 kg/m³ is obtained. Fine cells and a smooth surface was seen.

3d. A commercial low density polyethylene is mixed with 10% of a mixture of sodium bicarbonate and a citric acid derivative (e.g. Tracel INC 7200W) in an extruder at a temperature of 125° C. (melt temperature above 135° C.). After extrusion the sheet is crosslinked by radiation and foamed in an oven at 220-260° C. during at least 5 minutes. A foam with a density of 80 kg/m³ is obtained. Fine cells and a smooth surface was seen.

3e. A commercial low density polyethylene is mixed with 5% of a mixture of sodium bicarbonate and a citric acid derivative (e.g. Tracel NCS 175) in an extruder at a temperature of 125° C. (melt temperature above 135° C.). After extrusion the sheet is crosslinked by radiation and foamed in a laboratory oven at 220-260° C. A foam with a density of 300 kg/m³ is obtained. Fine cells and a smooth surface was seen.

3f. A commercial low density polyethylene is mixed with 10% of a mixture of sodium bicarbonate and a citric acid derivative (e.g. Tracel NCS 175; i.e. a combination of citric acid and a citric acid derivative) in an extruder at a temperature of 125° C. (melt temperature above 135° C.). After extrusion the sheet is crosslinked by radiation and foamed in an oven at 220-260° C. A foam with a density of 200 kg/m³ is obtained. Fine cells and a smooth surface was seen.

3g. A commercial low density polyethylene is mixed with 5% of a mixture of sodium bicarbonate and a citric acid derivative (e.g. Tracel NCS 175) in an extruder at a temperature of 125° C. (melt temperature above 135° C.). After extrusion the sheet is crosslinked by radiation and foamed in an oven at 220-260° C. A foam with a density of 125 kg/m³ is obtained. Fine cells and a smooth surface was seen.

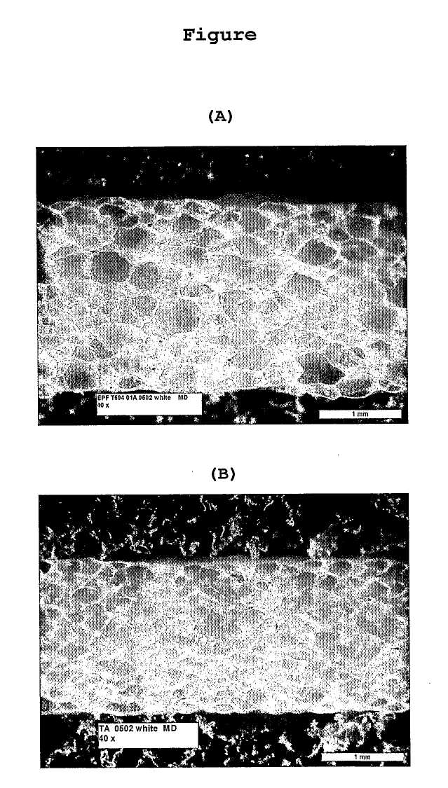

In FIG. 1 a comparison is shown of this foam and a foam produced by using azodicarbonamide. The cells in the foam produced with Tracel NCS 175 are coarser than in case of foams produced by using azodicarbonamide. The sizes of the cells are less than 0.7 mm, varying between 0.1 and 0.7 mm. Therefore, although as fine cells as with azodicarbonamide as a blowing agent were not obtained, the present invention provides a good alternative to foams obtained using azodicarbonamide.

The Examples 3.b to 3.e show that a ternary combination of the blowing agent has a particularly good combination of the properties density, pore size and surface smoothness.

1. A process for the production of a crosslinked polymer foam, which comprises:
(i) blending a polymer with an endothermic blowing agent,
(ii) forming the blend into a sheet,
(iii) crosslinking the sheet, and
(iv) foaming the sheet,
wherein the blowing agent is blended in an amount of 3 to 25%, based on the total weight of the polyolefin and the blowing agent, and is composed of the following endothermic components:
(A) 3 to 50% of one or more inorganic carbonates; and
(B) 50 to 97% of one or more compounds selected from the group consisting of polycarboxylic acids, salts thereof, and derivatives thereof.

2. The process according to claim 1, wherein the blowing agent is composed of
(A) 5 to 40% of one or more inorganic carbonates,
(B1) 10 to 60% of one or more polycarboxylic acids and/or salts thereof, and
(B2) 10 to 60% of one or more derivatives of polycarboxylic acids.

3. A process for the production of a crosslinked polyolefin foam, which comprises:
(i) blending a polyolefin with an endothermic blowing agent,
(ii) forming the blend into a sheet,
(iii) crosslinking the sheet, and
(iv) foaming the sheet,
wherein the blowing agent is composed of the following endothermic components:
(A) 5 to 40% of one or more inorganic carbonates,
(B1) 10 to 60% of one or more polycarboxylic acids and/or salts thereof, and
(B2) 10 to 60% of one or more derivatives of polycarboxylic acids.

4. The process according to claim 3, wherein components (A), (B1) and (B2) are blended with the polyolefin in an amount of 3 to 25%, based on the total weight of the polymer and the blowing agent.

5. The process according to claim 1, wherein the polymers are selected from the group consisting of polymers having a melting temperature of 130° C. or less and polyolefins.

6. The process according to claim 5, wherein the polymers are polyolefins selected from the group consisting of and ethylene-copolymers.

7. The process according to claim 1, wherein the blend is formed by extruding, kneading or calendering the blend into a sheet at a temperature of 130° C. or less.

8. The process according to claim 1, wherein the foaming is carried out at a temperature of 180 to 260° C.

9. The process according to claim 1, wherein the components of the blowing agent are blended with the polyolefin separately or as a mixture.

10. The process according to claim 1, wherein the inorganic carbonates are selected from sodium bicarbonate, sodium aluminum hydroxyl carbonate, and magnesium carbonate.

11. The process according to claim 1, wherein the polycarboxylic acids and salts thereof are selected from citric acid, fumaric acid, tartaric acid, sodium hydrogen citrate, disodium citrate and trisodium citrate.

12. The process according to claim 1, wherein the derivatives of polycarboxylic acids are selected from esters, amides, halides, and anhydrides.

13. The process according claim 1, wherein the blowing agent is blended in an amount of 4 to 20%.

14. A crosslinked polymer foam obtainable by a method as defined in claim 1.

15. The crosslinked polymer foam according to claim 14 which is free of semicarbazides.

16. The crosslinked polymer foam according to claim 14 having a density of 20 to 400 kg/m³.

17. The crosslinked polymer foam according to claim 14 having cell sizes of 0.05 to 2 mm.

18. A process for packaging or sealing products comprising a process as defined in claim 1 and further packaging or sealing the product or a container containing the product using the prepared foam.

19. The process according to claim 18, wherein the product is selected from the group consisting of food, beverages, pharmaceuticals, cosmetics and medical devices.

20. The process according to claim 18, wherein the foam is used as a packaging liner or sealing product selected from the group consisting of capsules, sealing rings, sealing washers, surface liners in packaging of containers, bins, cans, bottles, glass jars and boxes.

21. (canceled)

22. A crosslinked polymer foam as defined in claim 14, wherein the foam is a carrier for transdermal applications of medicine or as a plaster.

23. A crosslinked polymer foam as defined in claim 14, wherein the foam is a packaging liner or sealing product selected from the group consisting of capsules, sealing rings, sealing washers, surface liners in packaging of containers, bins, cans, bottles, glass jars and boxes.
